(19) United States
(12) Patent Application Publication
(10) Pub. No.: US 2024/0422826 A1
(43) Pub. Date: Dec. 19, 2024

(54) RESOURCE SELECTION FOR RANDOM ACCESS PROCEDURES

(71) Applicant: Nokia Technologies Oy, Espoo (FI)

(72) Inventors: Samuli Heikki TURTINEN, Oulu (FI); Jussi-Pekka KOSKINEN, Oulu (FI); Chunli WU, Beijing (CN); Benoist Pierre SEBIRE, Tokyo (JP); Tero HENTTONEN, Espoo (FI)

(21) Appl. No.: 18/701,847

(22) PCT Filed: Oct. 21, 2021
(86) PCT No.: PCT/CN2021/125424

§ 371 Date: Apr. 16, 2024

(51) Int. Cl. H04W 74/0833; H04W 74/00

(52) U.S. Cl. CPC H04W 74/0833; H04W 74/002

(57) ABSTRACT

Example embodiments of the present disclosure relate to resource selections of random access procedure. According to embodiments of the present disclosure, when a random access procedure is triggered for a certain feature combination, the terminal device determines the random access channel (RACH) partition to use based on a defined priority order of (RACH-partition) features whenever a RACH partition that would have matched the feature combination for which the RA procedure is triggered is not provided in the cell. The priority order could be pre-defined in the standards, provided by the Mobile Network Operators (MNO), or signaled dynamically by the network via system information or dedicated signaling (e.g., radio resource control (RRC) or medium access control (MAC) signaling). In this way, better resource selections may be achieved. Moreover, it does not need to configure resources for any possible combinations of features.

### FIELD

Embodiments of the present disclosure generally relate to the field of telecommunication and in particular, to methods, devices, apparatuses and computer readable storage medium for selecting resources for random access procedure.

### BACKGROUND

With development of communication systems, more and more technologies have been proposed. A physical random-access channel (PRACH) is a shared channel used by terminal devices to access the mobile network for cell set-up and burst data transmission. In order to access the PRACH, a terminal device may initiate a random access procedure. The terminal device needs to select proper resources for the random access procedure.

### SUMMARY

In general, example embodiments of the present disclosure provide a solution for selecting resources for random access procedure.

In a first aspect, there is provided a first device. The first device comprises at least one processor; and at least one memory including computer program codes; the at least one memory and the computer program codes are configured to, with the at least one processor, cause the first device to: determine that a random access procedure is triggered based on a plurality of features; determine, from a set of resources for the random access procedure, a first subset of resources allocated for a first feature in the plurality of features, the first feature having a first priority; determine, from the set of resources for the random access procedure, a second subset of resources allocated for a second feature in the plurality of features, the second feature having a second priority lower than the first priority; and in accordance with a determination that there are no overlapped resources between the first subset of resources and the second subset of resources, perform the random access procedure with a second device based on the first subset of resources.

In a second aspect, there is provided a first device. The first device comprises at least one processor; and at least one memory including computer program codes; the at least one memory and the computer program codes are configured to, with the at least one processor, cause the first device to determine that a random access procedure is triggered based on a plurality of features; determine, from a set of resources for the random access procedure, a first subset of resources allocated for a first feature in the plurality of features, the first feature having a first priority; determine, from the set of resources for the random access procedure, a second subset of resources allocated for a second feature in the plurality of features, the second feature having a second priority lower than the first priority; and in accordance with a determination that the first subset of resources does not overlap with the second subset of resources, perform the random access procedure with a second device based on other resources in the set of resources excluded the first subset of resources.

In a third aspect, there is provided a method. The method comprises determining, at a first device, that a random access procedure is triggered based on a plurality of features; determining, from a set of resources for the random access procedure, a first subset of resources allocated for a first feature in the plurality of features, the first feature having a first priority; determining, from the set of resources for the random access procedure, a second subset of resources allocated for a second feature in the plurality of features, the second feature having a second priority lower than the first priority; and in accordance with a determination that there are no overlapped resources between the first subset of resources and the second subset of resources, performing the random access procedure with a second device based on the first subset of resources.

In a fourth aspect, there is provided a method. The method comprises determining, at a first device, that a random access procedure is triggered based on a plurality of features; determining, from a set of resources for the random access procedure, a first subset of resources allocated for a first feature in the plurality of features, the first feature having a first priority; determining, from the set of resources for the random access procedure, a second subset of resources allocated for a second feature in the plurality of features, the second feature having a second priority lower than the first priority; and in accordance with a determination that the first subset of resources does not overlap with the second subset of resources, performing the random access procedure with a second device based on other resources in the set of resources excluded the first subset of resources.

In a fifth aspect, there is provided an apparatus. Thus apparatus comprises: means for determining that a random access procedure is triggered based on a plurality of features; means for determining, from a set of resources for the random access procedure, a first subset of resources allocated for a first feature in the plurality of features, the first feature having a first priority; means for determining, from the set of resources for the random access procedure, a second subset of resources allocated for a second feature in the plurality of features, the second feature having a second priority lower than the first priority; and means for in accordance with a determination that there are no overlapped resources between the first subset of resources and the second subset of resources, performing the random access procedure with a second device based on the first subset of resources.

In a sixth aspect, there is provided an apparatus. Thus apparatus comprises: means for determining that a random access procedure is triggered based on a plurality of features; means for determining, from a set of resources for the random access procedure, a first subset of resources allocated for a first feature in the plurality of features, the first feature having a first priority; means for determining, from the set of resources for the random access procedure, a second subset of resources allocated for a second feature in the plurality of features, the second feature having a second priority lower than the first priority; and means for in accordance with a determination that the first subset of resources does not overlap with the second subset of resources, performing the random access procedure with a second device based on other resources in the set of resources excluded the first subset of resources.

In a seventh aspect, there is provided a computer readable medium. The computer readable medium comprises program instructions for causing an apparatus to perform at least the method according to any one of the above third and fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for selecting proper resources for a random access procedure according to some example embodiments of the present disclosure;

FIGS. 3A-3D illustrate schematic diagrams of resource pools according to some example embodiments of the present disclosure, respectively;

FIG. 4 illustrates a flowchart of a method implemented at a first apparatus according to some example embodiments of the present disclosure;

FIG. 5 illustrates a flowchart of a method implemented at a first apparatus according to some example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, the gNB can be split into a centralized unit (CU) and a decentralized unit (DU). That CU hosts the higher layers of the protocol stack including the radio resource control (RRC) and packet data convergence protocol (PDCP) while the DU hosts the lower layers such as the physical layer, medium access control (MAC) layer and radio link control (RLC) layer.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the terminal device may initiate the random access procedure to access the PRACH. Random Access Procedure (RACH) can be contention based (CBRA) or contention free (CFRA). A technique named “RACH partition” has been proposed. The RACH partition strategy may be optimized to increase the access performances of networks. For example, based on different types of services, the RACH partition strategy may partition and allocate random access channel (RACH) resources to each type of service. The term “RACH resources” used herein can refer to time/frequency resources used for RACH (i.e., the so-called RACH occasions—ROs) and RACH partitioning can either be achieved by partitioning the PRACH resources (i.e., different RACH occasions are mapped to different features) or by partitioning the preambles associated with a RACH occasion (i.e., different preambles of a RO are mapped to different features).

However, it is not clear how to select a proper RACH partitioning for a combination of features causing the random access procedure. The combinations of features increase the chances of having to deal with RACH partition selection cases which are not straightforward. For instance, the data radio bearer (DRB) #1 and DRB #2 of slice #1/slice group #1 may be configured for small data transmission (SDT), however, the cell where the UE is camping may support slice #1/slice group #1 RACH partition and SDT RACH partition separately, while random access resources for a combination of such slice and SDT may not be provided. In another example, a reduced capability (RedCap) UE may be configured with a certain slice for which a separate RACH partition is provided in the cell, and at the same time, that cell may also provide a RedCap specific RACH partition. In other words, whenever a RACH partition that would combine multiple features for the given access of the UE does not exist, the selection of the RACH partition to use may not be clear when RA procedure is triggered for such a combination.

In order to solve at least part of the above and other potential problems, a new solution on selecting proper resources for a random access procedure is needed. According to embodiments of the present disclosure, when a random access procedure is triggered for a certain feature combination, the terminal device determines the RACH partition to use based on a defined priority order of (RACH-partition) features whenever a RACH partition that would have matched the feature combination for which the RA procedure is triggered is not provided in the cell. The priority order could be pre-defined in the standards, provided by the Mobile Network Operators (MNO), or signaled dynamically by the network via system information or dedicated signaling (e.g., RRC or MAC signaling). For example, the terminal device first checks random access resource partitions provided for the 1st priority feature of the certain feature combination, either in isolation or in combination with other features. Amongst those partitions the terminal device then checks if there are random access resource partitions configured for the 2nd priority feature of the certain feature combination (i.e. random access resource partitions configured for the 1st and the 2nd priority features either in isolation or in combination with other features). Amongst those partitions, the terminal device then checks if there are random access resource partitions configured for the 3rd priority feature of the certain feature combination (i.e., RA resource partitions configured for the 1st, 2nd and 3rd priority features either in isolation or in combination with other features) and so on. When no random access partition is configured for the certain feature combination, the terminal device then selects the RA resource configured for the highest priority level of the certain feature combination for which it could find one partition provided in isolation. In this way, better resource selections may be achieved. Moreover, it does not need to configure resources for any possible combinations of features.

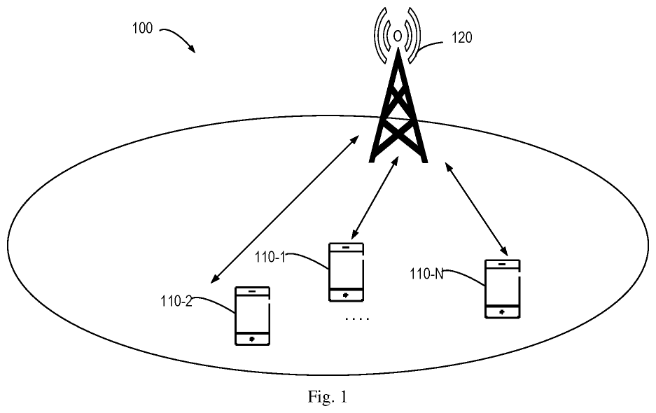

FIG. 1 illustrates a schematic diagram of a communication environment 100 in which embodiments of the present disclosure can be implemented. The communication environment 100, which is a part of a communication network, comprises a device 110-1, a device 110-2, . . . , a device 110-N, which can be collectively referred to as “first device(s) 110.” The communication environment 100 further comprises a second device 120 that can communicate with the first device(s) 110.

The communication environment 100 may comprise any suitable number of devices and cells. In the communication environment 100, the first device 110 and the second device 120 can communicate data and control information to each other. In the case that the first device 110 is the terminal device and the second device 120 is the network device, a link from the second device 120 to the first device 110 is referred to as a downlink (DL), while a link from the first device 110 to the second device 120 is referred to as an uplink (UL). The second device 120 and the first device 110 are interchangeable.

It is to be understood that the number of first devices and cells and their connections shown in FIG. 1 is given for the purpose of illustration without suggesting any limitations. The environment 100 may include any suitable number of devices and networks adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

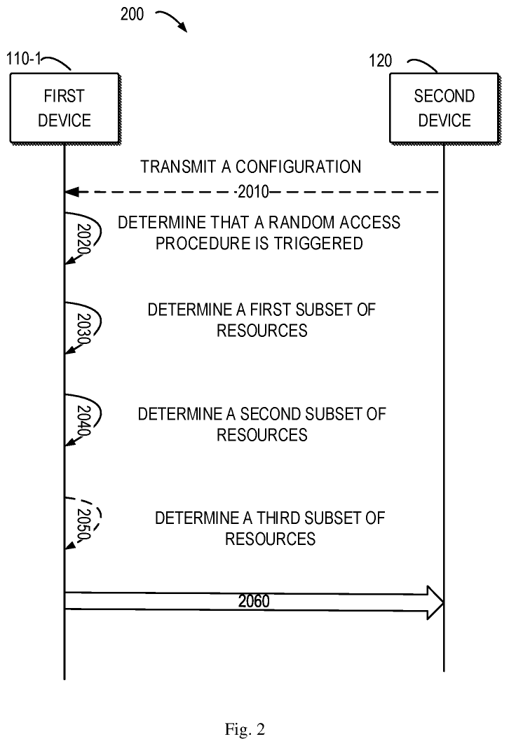

Example embodiments of the present disclosure will be described in detail below with reference to the accompanying drawings. Reference is now made to FIG. 2, which illustrates a signaling flow 200 for selecting resources for random access procedures according to example embodiments of the present disclosure. For the purpose of discussion, the signaling flow 200 will be described with reference to FIG. 1. The signaling flow 200 may involve the first device 110-1 and the second device 120.

In some example embodiments, the second device 120 may transmit 2010 a configuration to the first device 110-1. The configuration may comprise a set of features which can trigger a random access procedure. The configuration may also indicate a priority or priority level of each feature or feature combination. The term “feature” used herein can refer to a cause that can trigger the random access procedure. In some example embodiments, the priorities of the features can predetermined at the first device 110-1, for example pre-defined in the standards. Alternatively, the priorities of the features can be dynamically signaled by the second device 120 via system information or dedicated signaling (e.g., RRC or MAC signaling).

In some example embodiments, the priority of each feature or feature combination can be configured dynamically. Alternatively, the configuration may be predetermined at the first device 110-1 and the second device 120. Table 1 below shows example features for triggering the random access procedure. It should be noted that Table 1 is only one example and other combinations of features and priorities may be possible.

TABLE 1

| Feature | Reason for RACH indication |
|---|---|
| Reduced capability (RedCap) | To indicate reduced capabilities to the |
| | network in MSG1 so |
| | that the network can |
| | adapt subsequent transmissions |
| Small Data Transmission (SDT) | To request a larger MSG3 size |
| | (or MSGA size in case of 2-step RA) |
| | and to indicate SDT procedure. |
| Coverage Enhancement (CovEnh) | To indicate need for |
| | coverage enhancement |
| | (esp. for request of MSG3 repetition) |
| Slicing | To indicate high priority slice to the |
| | network and to achieve slice |
| | isolation also for RACH |

The first device 110-1 determines 2020 a random access procedure is triggered based on one or more of a plurality of features. For example, the plurality of features may comprise one or more of: RedCap, SDT, CovEnh or slicing. It should be noted that the plurality of features can comprise other features.

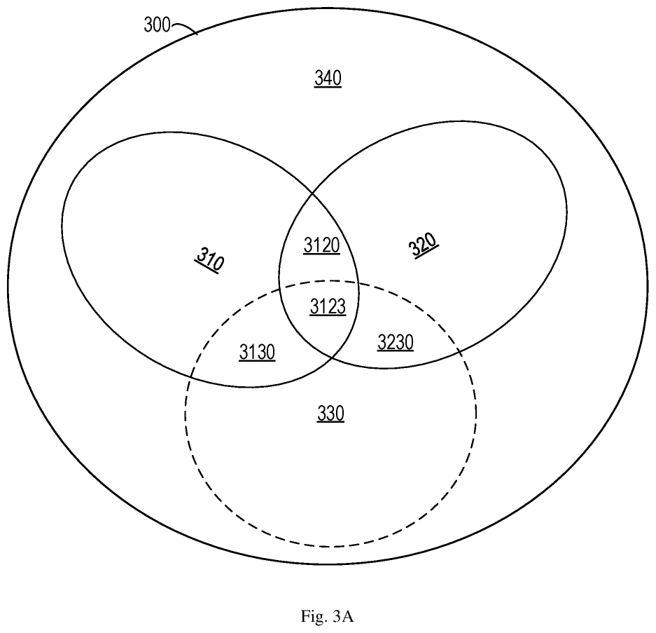

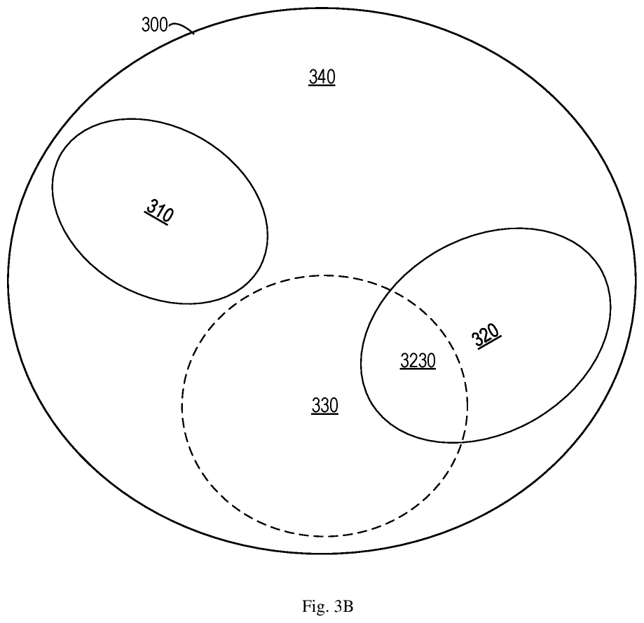

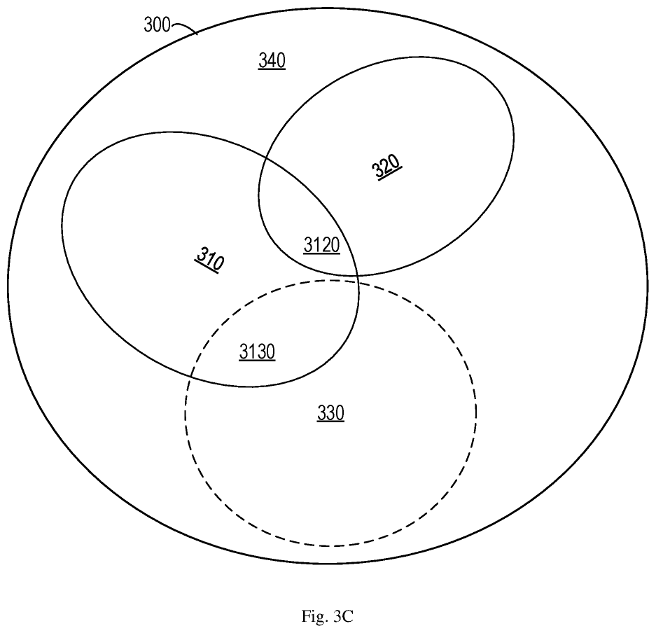

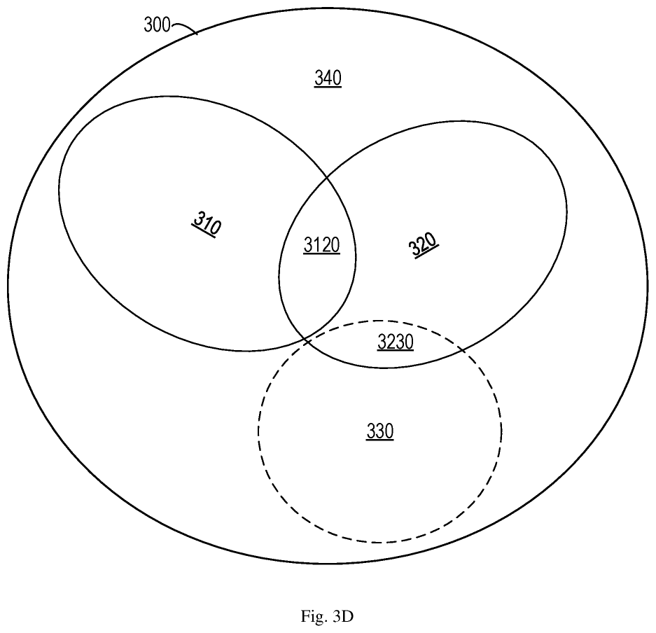

If the plurality of features comprises a first feature, the first device 110-1 determines 2030 a first subset of resources allocated for the first feature from a set of resources for the plurality of features. For example, the first device 110-1 may receive a resource configuration which indicates the set of resources from the second device 120. The first feature has a first priority. Referring to FIGS. 3A-3D, the set of resources 300 can be assigned for the plurality of features. The first device 110-1 can determine the first subset of resources 310 from the set of resources 300.

The first subset of resources may comprise a plurality of PRACH occasions and/or preambles allocated for the first feature. In this case, if the second device 120 receives a request for the random access procedure on the PRACH occasion in the plurality of PRACH occasions, the second device 120 may understand that the random access procedure is triggered by the first feature. Alternatively or in addition, the first subset of resources may comprise a plurality of preambles. In this case, if the second device 120 receives a preamble in the plurality of preambles, the second device 120 may understand that the random access procedure is triggered by the first feature.

In some example embodiments, if the plurality of features comprises a second feature, the first device 110-1 may determine 2040 a second subset of resources allocated for the second feature from the set of resources for the plurality of features. The second feature has a second priority which may be different from the first priority, e.g., lower than the first priority. Referring to FIGS. 3A-3D, the set of resources 300 can comprise the second subset of resources 320.

The second subset of resources may comprise a plurality of PRACH occasions and/or preambles allocated for the second feature. In this case, if the second device 120 receives a request for the random access procedure on the PRACH occasion in the plurality of PRACH occasions, the second device 120 may understand that the random access procedure is triggered by the second feature. Alternatively or in addition, the second subset of resources may comprise a plurality of preambles. In this case, if the second device 120 receives a preamble in the plurality of preambles, the second device 120 may understand that the random access procedure is triggered by the second feature.

In some example embodiments, if the plurality of features comprises a second feature, the first device 110-1 may determine 2050 a third subset of resources allocated for the third feature from the set of resources for the plurality of features. The third feature has a third priority which may be different from the first priority and the second priority, e.g., lower than the second priority. Referring to FIGS. 3A-3D, the set of resources 300 can comprise the third subset of resources 330.

In some example embodiments, if the plurality of features comprises a first feature and a second feature, the first device 110-1 may determine a fourth priority for the plurality of features or the combination of features. The fourth priority which may be different from the first priority and the second priority and the third priority, e.g., higher than first priority or higher than the second priority but lower than the first priority.

Referring back to FIG. 2, the first device 110-1 performs 2060 the random access procedure. In some example embodiments, the first device 110-1 can perform the random access procedure based on the first subset of resources. Alternatively, the first device 110-1 can perform the random access procedure based on other resources in the set of resources excluded the first subset of resources. Some example embodiments of the present disclosure are described with the reference to FIGS. 3A-3D below.

In some example embodiments, the plurality of features may comprise the first feature and the second feature. As shown in FIG. 3A, if the first subset of resources 310 overlaps with the second subset of resources 320, the first device 110-1 may perform the random access procedure based on the subset of overlapped resources 3120. Alternatively, as shown in FIG. 3B, if the first subset of resources 310 does not overlap with the second subset of resources 320, the first device 110-1 may perform the random access procedure based on the first subset of resources 310. In other embodiments, as shown in FIG. 3B, if the first subset of resources 310 does not overlap with the second subset of resources 320, the first device 110-1 may perform the random access procedure based on the subset of resources 340 which are not dedicated to the first feature or the second feature.

In an example embodiment, the first feature can be the coverage enhancement and the second feature can be the reduced capability. In this case, if the random access partitioning (i.e., the subset of overlapped resources 3120) is configured for the combination of the coverage enhancement and the reduced capability, the first device 110-1 may select the resources for the combination when performing the random access for such combination. Alternatively, if there is no RA partitioning configured for the combination of the coverage enhancement and the reduced capability (i.e., as shown in FIG. 3B, the first subset of resources 310 does not overlap with the second subset of resources 320), the first device 110-1 may select the resources for the coverage enhancement without indicating it is a reduced capability UE via preamble transmission when the random access procedure is triggered by the reduced capability terminal device in a coverage enhancement area.

In other example embodiments, the first feature can be the coverage enhancement and the second feature can be the SDT. In this case, if the random access partitioning (i.e., the subset of overlapped resources 3120) is configured for the combination of the coverage enhancement and the SDT, the first device 110-1 may select the resources for the combination when performing the random access for such combination. Alternatively, if there is no RA partitioning configured for the combination of the coverage enhancement and the SDT (i.e., as shown in FIG. 3B, the first subset of resources 310 does not overlap with the second subset of resources 320), the first device 110-1 may select the resources for the coverage enhancement without indicating SDT when the random access procedure is triggered for the SDT condition in a coverage enhancement area. In other words, the first device 110-1 may perform a non-SDT procedure or a regular RRC resume procedure.

In one example embodiment, the reduced capability partition may be prioritized over slice/SDT partition. In some example embodiments, the reduced capability partition may be prioritized over certain other partitions only in case where the first device 110-1 is a receiving reduced capability UE, e.g., the first device 110-1 is having only 1 receiver chain or 1RX antenna. Otherwise, the other partition may be prioritized (e.g. slice/slice group partition for the slice the first device accesses). In one embodiment, the second device 120 can configure over system information if the reduced capability partition shall be prioritized in the cell (e.g., to account different coverage of the Msg3 transmissions of the terminal device) or whether it can be down prioritized and rely on Msg3 based reduced capability indication.

In some example embodiments, the first device 110-1 may select the RACH partition (i.e., the RACH resources) that supports the most features of the current feature combination. If multiple options exist, the partition with the highest priority feature among the feature combination can be selected. Alternatively, the partition with the second highest priority among the feature combination can be selected, if the highest priority feature is provided by both partitions. In some example embodiments, the selection of the partition can be up to UE implementation option. For example, the plurality of features may comprise the first feature, the second feature and the third feature. As shown in FIG. 3A, if there a subset of overlapped resources 3123 among the first subset of resources 310, the second subset of resources 320 and the third subset of resources 330, the first device 110-1 may perform the random access procedure based on the subset of overlapped resources 3123.

Alternatively, as shown in FIG. 3B, if the first subset of resources 310 does not overlap with the second subset of resources 320 and the third subset of resources 330, the first device 110-1 may perform the random access procedure based on the first subset of resources 310. In other embodiments, as shown in FIG. 3B, if the third subset of resources 330 and the second subset of resources 320 overlaps with the third subset of resources 330, the first device 110-1 may perform the random access procedure based on the subset of overlapped resources 3230, since the subset of overlapped resources 3230 supports more features than that of the first subset of resources 310.

In some example embodiments, as shown in FIG. 3C, if the first subset of resources 310 overlaps with the second subset of resources 320 (the subset of resources 3130) and the third subset of resources 330 but the second subset of resources 320 does not overlap with the third subset of resources 330, the first device 110-1 may perform the random access procedure based on the subset of overlapped resources 3120. Alternatively, as shown in FIG. 3D, if the first subset of resources 310 overlaps with the second subset of resources 320, the second subset of resources 320 overlaps with the third subset of resources 330 but the first subset of resources 310 does not overlap with the third subset of resources 330, the first device 110-1 may perform the random access procedure based on the subset of overlapped resources 3120.

In other embodiments, the plurality of features may comprise a first slice and a second slice. In this case, the first slice and the second slice may have different priorities. For example, different slices can be configured with different priorities among the features. For instance, a certain slice is prioritized over any other feature (CE, RedCap, SDT), while another slice could have priority only over a subset of features (e.g., RedCap). In some example embodiments, the slice can be indicated by a slice ID. Alternatively, the slice can be indicated by a DRB ID. In other embodiments, the slice may be indicated by a protocol data unit (PDU) session ID.

In one embodiment, it can be configured to the first device 110-1 if a certain feature combination shall only use RACH partition configured for the given feature combination. Otherwise, common RACH (i.e., among legacy UEs) shall be used. For instance, the second device 120 may configure DRB #1 of certain slice for SDT but it may only use the SDT in case a cell supports RACH partition for SDT and for a slice group the slice belongs to.

In one embodiment, the SDT partition is always down prioritized whenever another RACH partition for a certain feature of the current feature combination exists (as data can anyway be transmitted in CONNECTED mode). In other words, if the plurality of features comprises the SDT, the SDT has a lowest priority among the plurality of features.

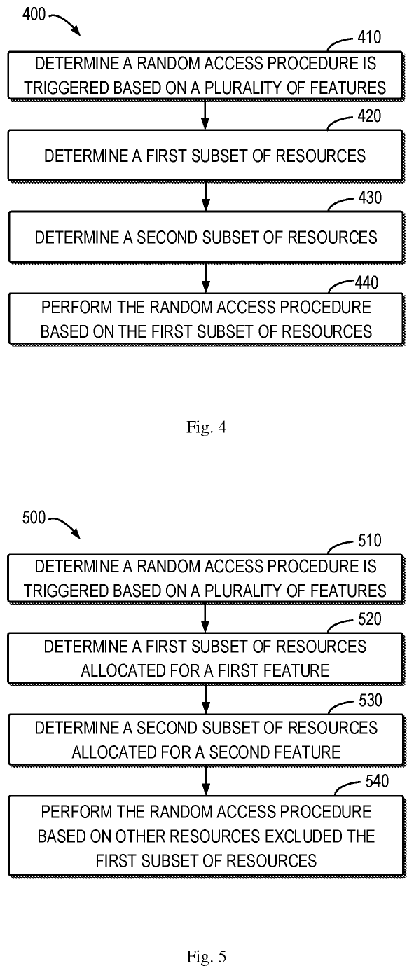

FIG. 4 shows a flowchart of an example method 400 implemented at a first device 110-1 in accordance with some example embodiments of the present disclosure.

In some example embodiments, the first device 110-1 may receive a configuration from the second device 120. The configuration may comprise a set of features which can trigger a random access procedure. The configuration may also indicate a priority of each feature. The term “feature” used herein can refer to a cause that can trigger the random access procedure. The priority order could be pre-defined in the standards, or signaled dynamically by the network via system information or dedicated signaling (e.g., RRC or MAC signaling).

In some example embodiments, the priority of each feature can be configured dynamically. Alternatively, the configuration may be predetermined at the first device 110-1 and the second device 120.

At block 410, the first device 110-1 determines that a random access procedure is triggered based on a plurality of features. For example, the plurality of features may comprise one or more of: RedCap, SDT, CovEnh or slicing. It should be noted that the plurality of features can comprise other features.

At block 420, the first device 110-1 determines a first subset of resources allocated for a first feature from a set of resources for the plurality of features. For example, the first device 110-1 may receive a resource configuration which indicates the set of resources from the second device 120. The first feature has a first priority.

The first subset of resources may comprise a plurality of PRACH occasions allocated for the first feature. In this case, if the second device 120 receives a request for the random access procedure on the PRACH occasion in the plurality of PRACH occasions, the second device 120 may understand that the random access procedure is triggered by the first feature. Alternatively or in addition, the first subset of resources may comprise a plurality of preambles. In this case, if the second device 120 receives a preamble in the plurality of preambles, the second device 120 may understand that the random access procedure is triggered by the first feature.

At block 430, if the plurality of features comprises a second feature, the first device 110-1 determines a second subset of resources allocated for the second feature from the set of resources for the plurality of features. The second feature has a second priority which is lower than the first priority.

The second subset of resources may comprise a plurality of PRACH occasions allocated for the second feature. In this case, if the second device 120 receives a request for the random access procedure on the PRACH occasion in the plurality of PRACH occasions, the second device 120 may understand that the random access procedure is triggered by the second feature. Alternatively or in addition, the second subset of resources may comprise a plurality of preambles. In this case, if the second device 120 receives a preamble in the plurality of preambles, the second device 120 may understand that the random access procedure is triggered by the second feature.

In some example embodiments, if the plurality of features comprises a second feature, the first device 110-1 may determine a third subset of resources allocated for the third feature from the set of resources for the plurality of features. The third feature has a third priority which is lower than the second priority.

At block 430, the first device 110-1 performs the random access procedure based on the first subset of resources. If the first subset of resources does not overlap with the second subset of resources, the first device 110-1 performs the random access procedure based on the first subset of resources. Alternatively, if the first subset of resources overlaps with the second subset of resources, the first device 110-1 may perform the random access procedure based on the subset of overlapped resources.

In an example embodiment, the first feature can be the coverage enhancement and the second feature can be the reduced capability. In this case, if the random access partitioning is configured for the combination of the coverage enhancement and the reduced capability, the first device 110-1 may select the resources for the combination when performing the random access for such combination. Alternatively, if there is no RA partitioning is configured for the combination of the coverage enhancement and the reduced capability, the first device 110-1 may the resources for the coverage enhancement without indicating it is a reduced capability UE via preamble transmission when the random access procedure is triggered by the reduced capability terminal device in a coverage enhancement area.

In other example embodiments, the first feature can be the coverage enhancement and the second feature can be the SDT. In this case, if the random access partitioning is configured for the combination of the coverage enhancement and the SDT, the first device 110-1 may select the resources for the combination when performing the random access for such combination. Alternatively, if there is no RA partitioning is configured for the combination of the coverage enhancement and the SDT, the first device 110-1 may the resources for the coverage enhancement without indicating SDT when the random access procedure is triggered the SDT condition in a coverage enhancement area. In other words, the first device 110-1 may perform non-SDT procedure.

In one example embodiment, the reduced capability partition may be prioritized over slice/SDT partition. In some example embodiments, the reduced capability partition may be prioritized over certain other partitions only in case where the first device 110-1 is a receiving reduced capability UE. Otherwise, the other partition may be prioritized (e.g., slice/slice group partition for the slice the first device accesses). In one embodiment, the second device 120 can configure over system information if the reduced capability partition shall be prioritized in the cell (e.g., to account different coverage of the Msg3 transmissions of the terminal device) or whether it can be down prioritized and rely on Msg3 based reduced capability indication.

In some example embodiments, the first device 110-1 may select the RACH partition (i.e., the RACH resources) that supports the most features of the current feature combination. If multiple options exist, the partition with the highest priority feature among the feature combination can be selected. Alternatively, the partition with the second highest priority among the feature combination can be selected, if the highest priority feature is provided by both partitions. In some example embodiments, the selection of the partition can be up to UE implementation option. For example, the plurality of features may comprise the first feature, the second feature and the third feature. Alternatively, if the first subset of resources does not overlap with the second subset of resources and the third subset of resources, the first device 110-1 may perform the random access procedure based on the first subset of resources.

In some example embodiments, if the first subset of resources overlaps with the second subset of resources and the third subset of resources but the second subset of resources does not overlap with the third subset of resources, the first device 110-1 may perform the random access procedure based on the subset of overlapped resources. Alternatively, if the first subset of resources overlaps with the second subset of resources, the second subset of resources overlaps with the third subset of resources but the first subset of resources does not overlap with the third subset of resources, the first device 110-1 may perform the random access procedure based on the subset of overlapped resources.

In other embodiments, the plurality of features may comprise a first slice and a second slice. In this case, the first slice and the second slice may have different priorities. For example, different slices can be configured with different priorities among the features. For instance, a certain slice is prioritized over any other feature (CE, RedCap, SDT), while another slice could have priority only over a subset of features (e.g., RedCap). In some example embodiments, the slice can be indicated by a slice ID. Alternatively, the slice can be indicated by a DRB ID. In other embodiments, the slice may be indicated by a protocol data unit (PDU) session ID.

In one embodiment, it can be configured to the first device 110-1 if certain feature combination shall only use RACH partition configured for the given feature combination. Otherwise, common RACH (i.e., among legacy UEs) shall be used. For instance, the second device 120 may configure DRB #1 of certain slice for SDT but it may only use the SDT in case a cell supports RACH partition for SDT and for a slice group the slice belongs to.

In one embodiment, the SDT partition is always down prioritized whenever another RACH partition for a certain feature of the current feature combination exists (as data can anyway be transmitted in CONNECTED mode). In other words, if the plurality of features comprises the SDT, the SDT has a lowest priority among the plurality of features.

FIG. 5 shows a flowchart of an example method 500 implemented at a first device 110-1 in accordance with some other example embodiments of the present disclosure.

In some example embodiments, the first device 110-1 may receive a configuration from the second device 120. The configuration may comprise a set of features which can trigger a random access procedure. The configuration may also indicate a priority of each feature. The term “feature” used herein can refer to a cause that can trigger the random access procedure. The priority order could be pre-defined in the standards, or signaled dynamically by the network via system information or dedicated signaling (e.g., RRC or MAC signaling).

In some example embodiments, the priority of each feature can be configured dynamically. Alternatively, the configuration may be predetermined at the first device 110-1 and the second device 120.

At block 510, the first device 110-1 determines that a random access procedure is triggered based on a plurality of features. For example, the plurality of features may comprise one or more of: RedCap, SDT, CovEnh or slicing. It should be noted that the plurality of features can comprise other features.

At block 520, the first device 110-1 determines a first subset of resources allocated for a first feature from a set of resources for the plurality of features. For example, the first device 110-1 may receive a resource configuration which indicates the set of resources from the second device 120. The first feature has a first priority.

The first subset of resources may comprise a plurality of PRACH occasions allocated for the first feature. In this case, if the second device 120 receives a request for the random access procedure on the PRACH occasion in the plurality of PRACH occasions, the second device 120 may understand that the random access procedure is triggered by the first feature. Alternatively or in addition, the first subset of resources may comprise a plurality of preambles. In this case, if the second device 120 receives a preamble in the plurality of preambles, the second device 120 may understand that the random access procedure is triggered by the first feature.

At block 530, if the plurality of features comprises a second feature, the first device 110-1 may determine a second subset of resources allocated for the second feature from the set of resources for the plurality of features. The second feature has a second priority which is lower than the first priority.

The second subset of resources may comprise a plurality of PRACH occasions allocated for the second feature. In this case, if the second device 120 receives a request for the random access procedure on the PRACH occasion in the plurality of PRACH occasions, the second device 120 may understand that the random access procedure is triggered by the second feature. Alternatively or in addition, the second subset of resources may comprise a plurality of preambles. In this case, if the second device 120 receives a preamble in the plurality of preambles, the second device 120 may understand that the random access procedure is triggered by the second feature.

In some example embodiments, if the plurality of features comprises a second feature, the first device 110-1 may determine a third subset of resources allocated for the third feature from the set of resources for the plurality of features. The third feature has a third priority which is lower than the second priority.

At block 540, if the first subset of resources does not overlap with the second subset of resources, the first device 110-1 performs the random access procedure based on other resources in the set of resources excluded the first subset of resources.

In some example embodiments, if the first subset of resources does not overlap with the second subset of resources, the first device 110-1 may perform the random access procedure based on the subset of resources which are not dedicate to the first feature or the second feature. In other words, the above subset of resources may not comprise the first and second subsets for the resources.

In an example embodiment, the first feature can be the coverage enhancement and the second feature can be the reduced capability. In this case, if the random access partitioning is configured for the combination of the coverage enhancement and the reduced capability, the first device 110-1 may select the resources for the combination when performing the random access for such combination. Alternatively, if there is no RA partitioning is configured for the combination of the coverage enhancement and the reduced capability, the first device 110-1 may the resources for the coverage enhancement without indicating it is a reduced capability UE via preamble transmission when the random access procedure is triggered by the reduced capability terminal device in a coverage enhancement area.

In other example embodiments, the first feature can be the coverage enhancement and the second feature can be the SDT. In this case, if the random access partitioning is configured for the combination of the coverage enhancement and the SDT, the first device 110-1 may select the resources for the combination when performing the random access for such combination. Alternatively, if there is no RA partitioning is configured for the combination of the coverage enhancement and the SDT, the first device 110-1 may the resources for the coverage enhancement without indicating SDT when the random access procedure is triggered the SDT condition in a coverage enhancement area. In other words, the first device 110-1 may perform non-SDT procedure.

In one example embodiment, the reduced capability partition may be prioritized over slice/SDT partition. In some example embodiments, the reduced capability partition may be prioritized over certain other partitions only in case where the first device 110-1 is a receiving reduced capability UE. Otherwise, the other partition may be prioritized (e.g., slice/slice group partition for the slice the first device accesses). In one embodiment, the second device 120 can configure over system information if the reduced capability partition shall be prioritized in the cell (e.g., to account different coverage of the Msg3 transmissions of the terminal device) or whether it can be down prioritized and rely on Msg3 based reduced capability indication.

In some example embodiments, the first device 110-1 may select the RACH partition (i.e., the RACH resources) that supports the most features of the current feature combination. If multiple options exist, the partition with the highest priority feature among the feature combination can be selected. Alternatively, the partition with the second highest priority among the feature combination can be selected, if the highest priority feature is provided by both partitions. In some example embodiments, the selection of the partition can be up to UE implementation option. For example, the plurality of features may comprise the first feature, the second feature and the third feature.

Alternatively, if the first subset of resources does not overlap with the second subset of resources and the third subset of resources, the first device 110-1 may perform the random access procedure based on the subset of overlapped resources, since the subset of overlapped resources supports more features than that of the first subset of resources.

In other embodiments, the plurality of features may comprise a first slice and a second slice. In this case, the first slice and the second slice may have different priorities. For example, different slices can be configured with different priorities among the features. For instance, a certain slice is prioritized over any other feature (CE, RedCap, SDT), while another slice could have priority only over a subset of features (e.g., RedCap). In some example embodiments, the slice can be indicated by a slice ID. Alternatively, the slice can be indicated by a DRB ID. In other embodiments, the slice may be indicated by a protocol data unit (PDU) session ID.

In one embodiment, it can be configured to the first device 110-1 if certain feature combination shall only use RACH partition configured for the given feature combination. Otherwise, common RACH (i.e., among legacy UEs) shall be used. For instance, the second device 120 may configure DRB #1 of certain slice for SDT but it may only use the SDT in case a cell supports RACH partition for SDT and for a slice group the slice belongs to.

In one embodiment, the SDT partition is always down prioritized whenever another RACH partition for a certain feature of the current feature combination exists (as data can anyway be transmitted in CONNECTED mode). In other words, if the plurality of features comprises the SDT, the SDT has a lowest priority among the plurality of features.

In some example embodiments, a first apparatus capable of performing any of the method 400 (for example, the first device 110) may comprise means for performing the respective operations of the method 400. The means may be implemented in any suitable form. For example, the means may be implemented in a circuitry or software module. The first apparatus may be implemented as or included in the first device 110. In some example embodiments, the means may comprise at least one processor and at least one memory including computer program code. The at least one memory and computer program code are configured to, with the at least one processor, cause performance of the apparatus.

In some example embodiments, the apparatus comprises means for determining that a random access procedure is triggered based on a plurality of features; means for determining, from a set of resources for the random access procedure, a first subset of resources allocated for a first feature in the plurality of features, the first feature having a first priority; means for determining, from the set of resources for the random access procedure, a second subset of resources allocated for a second feature in the plurality of features, the second feature having a second priority lower than the first priority; and means for in accordance with a determination that there are no overlapped resources between the first subset of resources and the second subset of resources, performing the random access procedure with a second device based on the first subset of resources.

In some example embodiments, the plurality of features comprises a third feature which has a third priority lower than the second priority, the apparatus comprises: means for determining, from the set of resources for the random access procedure, a third subset of resources allocated for the third feature.

In some example embodiments, the means for performing the random access procedure comprises: means for in accordance with a determination that the first subset of resources does not overlap with the second and third subsets of resources and a determination that there is a subset of overlapped resources between the second and third subsets of resources, performing the random access procedure based on the first subset of resources.

In some example embodiments, the first priority and the second priority are configured by the second device via radio resource control signaling, or wherein the first priority and the second priority are predetermined at the first device.

In some example embodiments, the plurality of features comprises at least two of: a reduced capability, a small data transmission, a coverage enhancement, or a slice.

In some example embodiments, the plurality of features comprises a small data transmission (SDT), and the SDT has a lowest priority among the plurality of features.

In some example embodiments, the plurality of features comprises a first slice and a second slice, and the first and second slices have different priorities.

In some example embodiments, a first apparatus capable of performing any of the method 500 (for example, the first device 110) may comprise means for performing the respective operations of the method 500. The means may be implemented in any suitable form. For example, the means may be implemented in a circuitry or software module. The first apparatus may be implemented as or included in the first device 110. In some example embodiments, the means may comprise at least one processor and at least one memory including computer program code. The at least one memory and computer program code are configured to, with the at least one processor, cause performance of the apparatus.

In some example embodiments, the apparatus comprises means for determining that a random access procedure is triggered based on a plurality of features; mans for determining, from a set of resources for the random access procedure, a first subset of resources allocated for a first feature in the plurality of features, the first feature having a first priority; means for determining, from the set of resources for the random access procedure, a second subset of resources allocated for a second feature in the plurality of features, the second feature having a second priority lower than the first priority; and means for in accordance with a determination that the first subset of resources does not overlap with the second subset of resources, performing the random access procedure with a second device based on other resources in the set of resources excluded the first subset of resources.

In some example embodiments, the means for performing the random access procedure comprises: means for performing the random access procedure based on the other resources in the set of resources excluded the first and second subsets of resources.

In some example embodiments, the plurality of features comprises a third feature which has a third priority lower than the second priority, wherein the apparatus comprises means for determining, from the set of resources for the random access procedure, a third subset of resources allocated for the third feature.

In some example embodiments, the means for performing the random access procedure comprises: means for in accordance with a determination that the first subset of resources does not overlap with the second and third subsets of resources and a determination that there is a subset of overlapped resources between the second and third subsets of resources, performing the random access procedure based on the subset of overlapped resources between the second and third subsets of resources.

In some example embodiments, the first priority and the second priority are configured by the second device via radio resource control signaling, or wherein the first priority and the second priority are predetermined at the first device.

In some example embodiments, the plurality of features comprises at least two of: a reduced capability, a small data transmission, a coverage enhancement, or a slice.

In some example embodiments, the plurality of features comprises a small data transmission (SDT), and the SDT has a lowest priority among the plurality of features.

In some example embodiments, the plurality of features comprises a first slice and a second slice, and the first and second slices have different priorities.

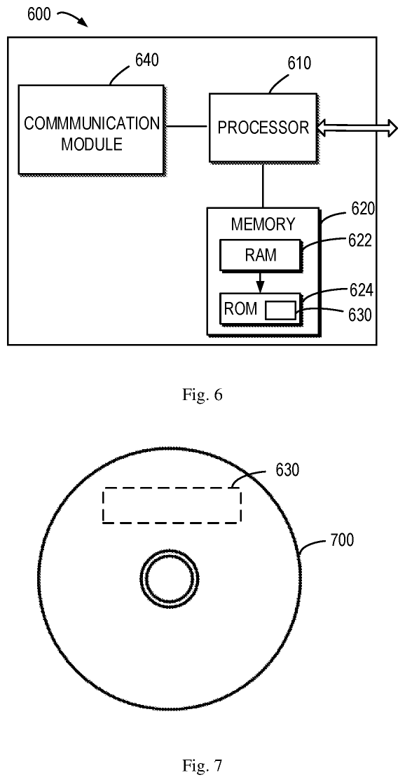

FIG. 6 is a simplified block diagram of a device 600 that is suitable for implementing example embodiments of the present disclosure. The device 600 may be provided to implement a communication device, for example, the first device 110 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the memory, e.g., ROM 624. The processor 610 may perform any suitable actions and processing by loading the program 630 into the RAM 622.

Some example embodiments of the present disclosure may be implemented by means of the program 630 so that the device 600 may perform any process of the disclosure as discussed with reference to FIGS. 2 to 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and other magnetic storage and/or optical storage. FIG. 7 shows an example of the computer readable medium 700 in form of an optical storage disk. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 2 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-35. (canceled)

36. A first device, comprising:
at least one processor; and
at least one memory including computer program code;
wherein the at least one memory and the computer program code are configured to, with the at least one processor, cause the first device to:
determine that a random access procedure is triggered based on a plurality of features;
determine, from a set of resources for the random access procedure, a first subset of resources allocated for a first feature in the plurality of features, the first feature having a first priority;
determine, from the set of resources for the random access procedure, a second subset of resources allocated for a second feature in the plurality of features, the second feature having a second priority lower than the first priority; and
in accordance with a determination that there are no overlapped resources between the first subset of resources and the second subset of resources, perform the random access procedure with a second device based on the first subset of resources.

37. The first device of claim 36, wherein the plurality of features comprises a third feature which has a third priority lower than the second priority, wherein the at least one memory and the computer program codes are configured to, with the at least one processor, further cause the first device to:
determine, from the set of resources for the random access procedure, a third subset of resources allocated for the third feature.

38. The first device of claim 37, wherein the at least one memory and the computer program codes are configured to, with the at least one processor, further cause the first device to perform the random access procedure by:
in accordance with a determination that the first subset of resources does not overlap with the second and third subsets of resources and a determination that there is a subset of overlapped resources between the second and third subsets of resources, performing the random access procedure based on the first subset of resources.

39. The first device of claim 36, wherein the first priority and the second priority are configured by the second device via radio resource control signaling, or
wherein the first priority and the second priority are predetermined at the first device.

40. The first device of claim 36, wherein the plurality of features comprises at least two of:
a reduced capability,
a small data transmission,
a coverage enhancement, or
a slice.

41. The first device of claim 36, wherein the plurality of features comprises a small data transmission (SDT), and the SDT has a lowest priority among the plurality of features.

42. The first device of claim 36, wherein the plurality of features comprises a first slice and a second slice, and the first and second slices have different priorities.

43. The first device of claim 36, wherein the first device is a terminal device and the second device is a network device.

44. A first device, comprising:
at least one processor; and
at least one memory including computer program code;
wherein the at least one memory and the computer program code are configured to, with the at least one processor, cause the first device to:
determine that a random access procedure is triggered based on a plurality of features;
determine, from a set of resources for the random access procedure, a first subset of resources allocated for a first feature in the plurality of features, the first feature having a first priority;
determine, from the set of resources for the random access procedure, a second subset of resources allocated for a second feature in the plurality of features, the second feature having a second priority lower than the first priority; and
in accordance with a determination that the first subset of resources does not overlap with the second subset of resources, perform the random access procedure with a second device based on other resources in the set of resources excluded the first subset of resources.

45. The first device of claim 44, wherein the at least one memory and the computer program codes are configured to, with the at least one processor, further cause the first device to perform the random access procedure by:
performing the random access procedure based on the other resources in the set of resources excluded the first and second subsets of resources.

46. The first device of claim 44, wherein the plurality of features comprises a third feature which has a third priority lower than the second priority, wherein the plurality of features comprises a third feature which has a third priority lower than the second priority, wherein the at least one memory and the computer program codes are configured to, with the at least one processor, further cause the first device to:
determine, from the set of resources for the random access procedure, a third subset of resources allocated for the third feature.

47. The first device of claim 46, wherein the at least one memory and the computer program codes are configured to, with the at least one processor, further cause the first device to perform the random access procedure by:
in accordance with a determination that the first subset of resources does not overlap with the second and third subsets of resources and a determination that there is a subset of overlapped resources between the second and third subsets of resources, performing the random access procedure based on the subset of overlapped resources between the second and third subsets of resources.

48. The first device of claim 44, wherein the plurality of features comprises at least two of:
a reduced capability,
a small data transmission,
a coverage enhancement, or
a slice.

49. The first device of claim 44, wherein the plurality of features comprises a small data transmission (SDT), and the SDT has a lowest priority among the plurality of features.

50. The first device of claim 44, wherein the plurality of features comprises a first slice and a second slice, and the first and second slices have different priorities.

51. The first device of claim 44, wherein the first device is a terminal device and the second device is a network device.

52. A method, comprising:
determining, at a first device, that a random access procedure is triggered based on a plurality of features;
determining, from a set of resources for the random access procedure, a first subset of resources allocated for a first feature in the plurality of features, the first feature having a first priority;
determining, from the set of resources for the random access procedure, a second subset of resources allocated for a second feature in the plurality of features, the second feature having a second priority lower than the first priority; and
in accordance with a determination that there are no overlapped resources between the first subset of resources and the second subset of resources, performing the random access procedure with a second device based on the first subset of resources.

53. The method of claim 52, wherein the plurality of features comprises a third feature which has a third priority lower than the second priority, wherein the method comprises:
determining, from the set of resources for the random access procedure, a third subset of resources allocated for the third feature.

54. The method of claim 53, wherein performing the random access procedure comprises:
in accordance with a determination that the first subset of resources does not overlap with the second and third subsets of resources and a determination that there is a subset of overlapped resources between the second and third subsets of resources, performing the random access procedure based on the first subset of resources.

55. The method of claim 52, wherein the first priority and the second priority are configured by the second device via radio resource control signaling, or
wherein the first priority and the second priority are predetermined at the first device.
